(19) United States
(12) Patent Application Publication
(10) Pub. No.: US 2023/0223663 A1
(43) Pub. Date: Jul. 13, 2023

(54) Anode and Cathode Tab Architecture for Parallel Connection of Batteries

(71) Applicant: META PLATFORMS TECHNOLOGIES, LLC, Menlo Park, CA (US)

(72) Inventors: Karthik Kadirvel, San Jose, CA (US); Jason Howard, Alpharetta, GA (US); Myuran Kangatharalingam, Sunnyvale, CA (US)

(21) Appl. No.: 16/544,500

(22) Filed: Aug. 19, 2019

Related U.S. Application Data
(60) Provisional application No. 62/791,681, filed on Jan. 11, 2019.

(51) Int. Cl. H01M 2/26; H01M 2/20; H01M 2/10; H01M 10/0525; H01M 10/0585

(52) U.S. Cl. CPC H01M 2/266; H01M 2/204; H01M 2/1061; H01M 10/0525; H01M 10/0585; H01M 2220/30

(57) ABSTRACT

A battery system includes a plurality of battery cells connected in parallel. Each battery cell includes a pair of positive and negative tabs extending from each of two opposing sides. The battery system also includes one or more pairs of adjacent joining pads, each pair connecting the positive and negative tabs of adjacent battery cells. The battery system also includes a terrace portion. The positive tab and the negative tab corresponding to one side of a battery cell at one end of the parallel connection extend out onto the terrace portion. A pair of bus-bars placed in the terrace portion allow the extension of the tabs. Each joining pad is made of a flexible material so as to allow the positive and negative tabs of adjacent battery cells to bend around the respective joining pad. The battery system can be configured in various shapes, such as curved.

### TECHNICAL FIELD

The disclosed implementations relate generally to battery systems, and more specifically to battery systems with tab architectures suitable for parallel connection of batteries.

### BACKGROUND

Many consumer electronic products use lithium ion (Li-ion) batteries as power sources. These batteries are housed in plastic or metallic enclosures, which are designed to be compact to meet product use-case and aesthetic requirements. In typical batteries, the positive and negative terminals are on the same side of the battery or on opposite sides. To increase battery capacity, multiple pouch cells are connected in parallel (multi P) or in series (multi S). Unfortunately, connecting these typical batteries requires complex wiring arrangements and pack designs. Because battery manufacturing has to be economical, newer techniques have to build on existing methods. Moreover, batteries used in consumer devices have to be suitable for use in form fitting situations, such as VR headsets and wearables, where the battery has to fit around curved surfaces (e.g., around a head, a wrist, or a neck).

### SUMMARY

Accordingly, there is a need for a battery design that reduces complexity in pack design. There is also a need for battery manufacturing techniques that build on existing methods in order to be economical. Batteries designed and manufactured using the techniques described herein can be used in wearable computers or VR headsets as form factor cells.

In one aspect, a battery system includes a plurality of battery cells connected in parallel. Each battery cell includes a pair of positive and negative tabs extending from each of two opposing sides. Each battery cell also includes one or more pairs of adjacent joining pads. Each pair of adjacent joining pads connects the respective positive and negative tabs of respective adjacent battery cells.

In some implementations, the positive tab and the negative tab corresponding to one side of a battery cell at one end of the parallel connection extend out on a terrace portion of the battery system. In some implementations, the battery system further includes a pair of bus-bars placed in the terrace portion. The pair of bus-bars includes a first bus-bar placed under the positive tab and a second bus-bar placed under the negative tab.

In some implementations, each joining pad is made of a flexible material so as to allow the respective positive and negative tabs of respective adjacent battery cells to bend radially around the respective joining pad. In some implementations, the battery system is curved. The joining pads define one or more contours for the shape of the battery system. In some implementations, the battery cells have non-cuboidal shapes.

In some implementations, the battery system further comprises a first plurality of battery cells connected in parallel, and a second plurality of battery cells connected in parallel.

In some implementations, each joining pad is made of a respective conducting material that corresponds to the respective material of the respective positive or negative tabs.

In some implementations, a battery cell at one end of the parallel connection is connected to a pack connector.

In another aspect, a method of manufacturing a battery is provided. The method includes providing one or more positive electrode strips substantially equal in size, each positive electrode strip having a respective end portion that extends outwardly. The method also includes providing one or more negative electrode strips substantially equal in size to the positive electrode strips, each negative electrode strip having a respective end portion that extends outwardly. The method further includes attaching a positive tab to each end portion of the one or more positive electrode strips. Each positive tab is substantially perpendicular to and extends along each of two opposing sides of the respective positive electrode strip. The method also includes attaching a negative tab to each end portion of the one or more negative electrode strips. Each negative tab is substantially perpendicular to and extends along each of two opposing sides of the respective negative electrode strip. The method also includes layering the one or more positive electrode strips and the one or more negative electrode strips so that the end portions of the one or more positive electrode strips are disposed away from the end portions of the one or more negative electrode strips. Each positive electrode strip is separated from a respective negative electrode strip by a respective separator strip. The method further includes packaging the layering in a pouch container. The pouch container has a seal on at least two opposing sides. The layering is disposed in the pouch container so that a respective pair of negative and positive tabs extend out through at least two of the seals.

In some implementations, the method further includes joining each of the negative tabs using a pair of negative extension tabs, each negative extension tab extending from an opposing side of the layering, and joining each of the positive tabs using a pair of positive extension tabs, each positive extension tab extending from an opposing side of the layering. The respective pairs of negative and positive tabs extending out through each of the seals comprises the pairs of negative extension tabs and positive extension tabs.

In some implementations, the one or more positive electrode strips includes a first positive electrode strip, and the one or more negative electrode strips includes a first negative electrode strip. The method includes layering the one or more positive electrode strips and the one or more negative electrode strips by interposing a separator strip between the first negative electrode strip and the first positive electrode strip. The method also winds the first negative electrode strip, the separator strip, and the first positive electrode strip together to form a roll. In the roll, the positive and negative tabs are disposed away from each other and extend outward from opposing sides of the roll.

In some implementations, the method further includes curving the roll around the winding axis using thermal pressing to form a curve-shaped battery cell.

In some implementations, the method further includes curving the layering around an axis parallel to the negative and positive tabs using thermal pressing.

In some implementations, the method further includes curving the layering around an axis perpendicular to the negative and positive tabs using thermal pressing.

In some implementations, the method further includes creating a notch on one side of the layering. The notch coincides with either the positive or the negative tab. The notch includes a cut through a portion of the one or more positive electrode strips, the one or more negative electrode strips, and the positive or the negative tab corresponding to the side of the layering. The pouch container has an opening that is aligned with the notch. The method also includes packaging the layering in the pouch container by placing the layering in the pouch container so that the notch in the layering is aligned with the opening in the pouch container.

In some implementations, the method further includes stacking a first layering over a second layering. The first layering includes a first one or more positive electrode strips and a first one or more negative electrode strips, and the second layering includes a second one or more positive electrode strips and a second one or more negative electrode. The stacking includes aligning the negative and positive tabs of the first layering and the second layering. The method also includes joining each of the negative tabs of the first layering and the second layering using a second pair of negative extension tabs. Each negative extension tab of the second pair of negative extension tabs extends from an opposing side of the first layering and the second layering. The method further includes joining each of the positive tabs of the first layering and the second layering using a second pair of positive extension tabs. Each positive extension tab of the second pair of positive extension tabs extends from an opposing side of the first layering and the second layering.

In another aspect, a battery system includes one or more positive electrode strips substantially equal in size and each positive electrode strip has a respective end portion that extends outwardly, according to some implementations. The battery system also includes one or more negative electrode strips substantially equal in size to the positive electrode strips. Each negative electrode strip has a respective end portion that extends outwardly. The battery system also includes a pouch container having a seal on at least two opposing sides. The battery system is manufactured by a method that includes attaching a positive tab to each of the respective end portions of the one or more positive electrode strips. Each positive tab is substantially perpendicular to each of two opposing sides of the respective positive electrode strip. The method of manufacturing also includes attaching a negative tab to each of the respective end portions of the one or more negative electrode strips. Each negative tab is substantially perpendicular to each of two opposing sides of the respective negative electrode strip. The method of manufacturing also includes layering the one or more positive electrode strips and the one or more negative electrode strips so that the end portions of the one or more positive electrode strips are disposed away from the end portions of the one or more negative electrode strips. Each positive electrode strip is separated from a respective negative electrode strip by a respective separator strip. The method of manufacturing also includes packaging the layering in the pouch container. The layering is disposed in the pouch container so that a respective pair of negative and positive tabs extend out through at least two of the seals.

In another aspect, a battery system is provided that includes a plurality of battery cells connected in parallel. Each battery cell includes a pair of positive and negative tabs extending from each of two opposing sides. The respective positive tabs of respective adjacent battery cells are electrically connected, and the respective negative tabs of respective adjacent battery cells are electrically connected.

Thus apparatuses and methods are provided for battery systems that efficiently use multiple battery cells.

### BRIEF DESCRIPTION OF THE DRAWINGS

For a better understanding of the aforementioned implementations of the invention as well as additional implementations, reference should be made to the Description of Implementations below, in conjunction with the following drawings, in which like reference numerals refer to corresponding parts throughout the figures.

FIGS. 1A-1D illustrate conventional battery systems.

FIGS. 2A and 2B illustrate battery systems based on batteries with anode and cathode tabs extending from the sides, according to some implementations.

FIG. 2C illustrates a single battery cell according to some implementations.

FIG. 3A illustrates a conventional process of manufacturing a battery by rolling, and FIG. 3B illustrates a conventional process of manufacturing a battery by stacking.

FIGS. 4A and 4B illustrate adaptation of conventional manufacturing techniques of rolling and stacking for batteries with anode and cathode tabs extending from the sides, according to some implementations.

FIG. 5 illustrates various configurations of battery systems, according to some implementations.

FIGS. 6A-6C illustrate curved configurations of battery systems, according to some implementations.

FIG. 7 illustrates a stacked and notched configuration of a battery system, according to some implementations.

FIGS. 8A-8C illustrate a stacked stepped cell architecture, according to some implementations.

FIGS. 9A-9G provide a flowchart of a method of manufacturing battery systems, according to some implementations.

FIG. 10 illustrates an embodiment of an artificial reality device.

FIG. 11 illustrates an embodiment of an augmented reality headset and a corresponding neckband.

FIG. 12 illustrates an embodiment of a virtual reality headset.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

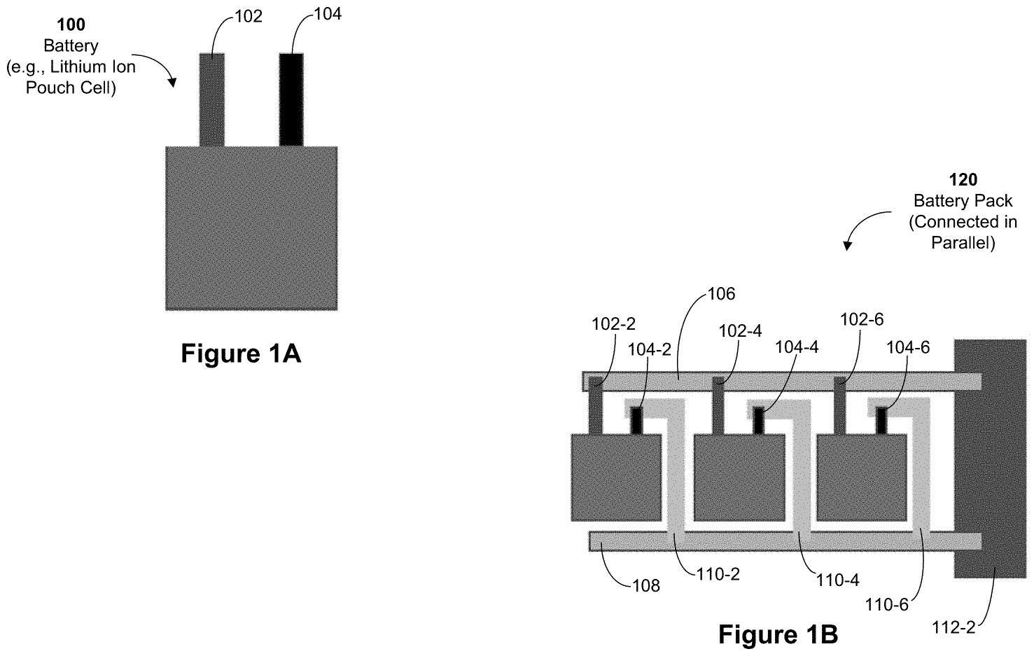

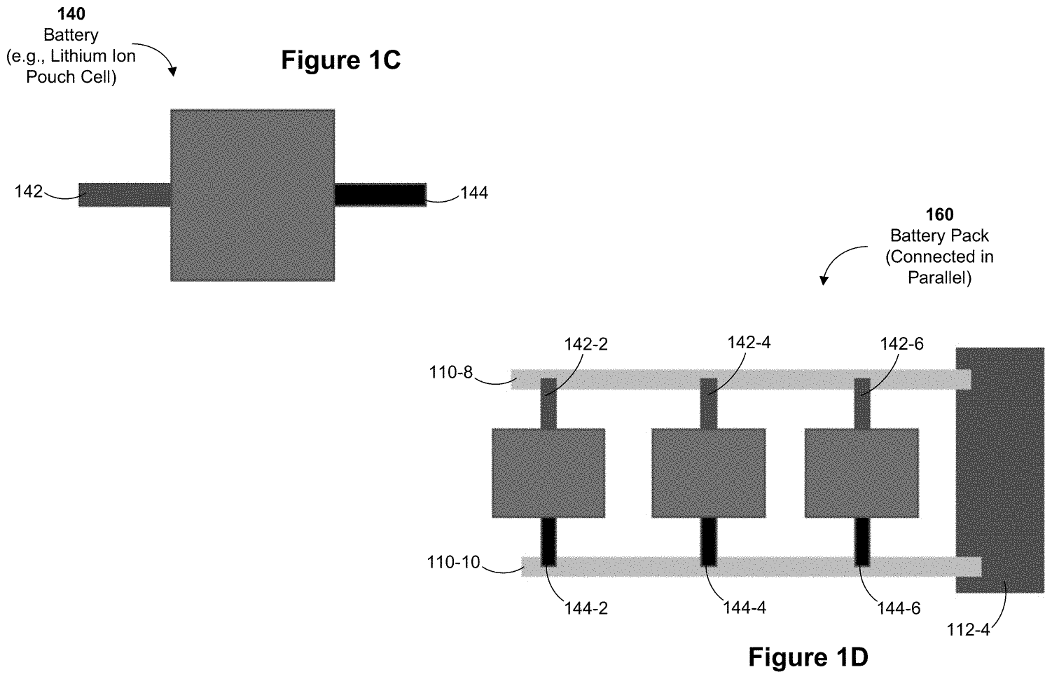

FIGS. 1A-1D illustrate conventional battery systems. FIG. 1A illustrates a battery 100 (a lithium ion pouch cell) with a cathode tab 102 (sometimes called a positive terminal) and an anode tab 104 (sometimes called a negative terminal) extending from the top of the battery (i.e., from the same side of the battery). FIG. 1C illustrates a battery 140 (another lithium ion pouch cell) with terminals 142 and 144 on opposite sides. Typically, a plurality of pouch cells, such as the battery 100 or the battery 140, are connected in parallel or series (using printed circuit boards (PCBs), copper bus bars, or wire bundles) to increase capacity of a battery pack (e.g., to increase system run time). FIG. 1B illustrates a 3P (3 parallel) pack 120 of pouch cells connected in parallel, each with a positive terminal (terminals 102-2, 102-4, and 102-6), and a negative terminal (terminals 104-2, 104-4, and 104-6). A first PCB 106 connects the positive terminals, and a second PCB 108 connects the negative terminals via the respective copper bus bars (110-2, 110-4, and 110-6), to the pack connector 112-2. As illustrated, the connections need complex routing of the connections. Similarly, FIG. 1D illustrates a battery pack 160 with three cells connected in parallel. Tabs extending from opposite sides (positive terminals 142-2, 142-4, and 142-6 and negative terminals 144-2, 144-4, and 144-6) are connected in parallel using two bus bars 110-8 and 110-10 to the pack connector 112-4.

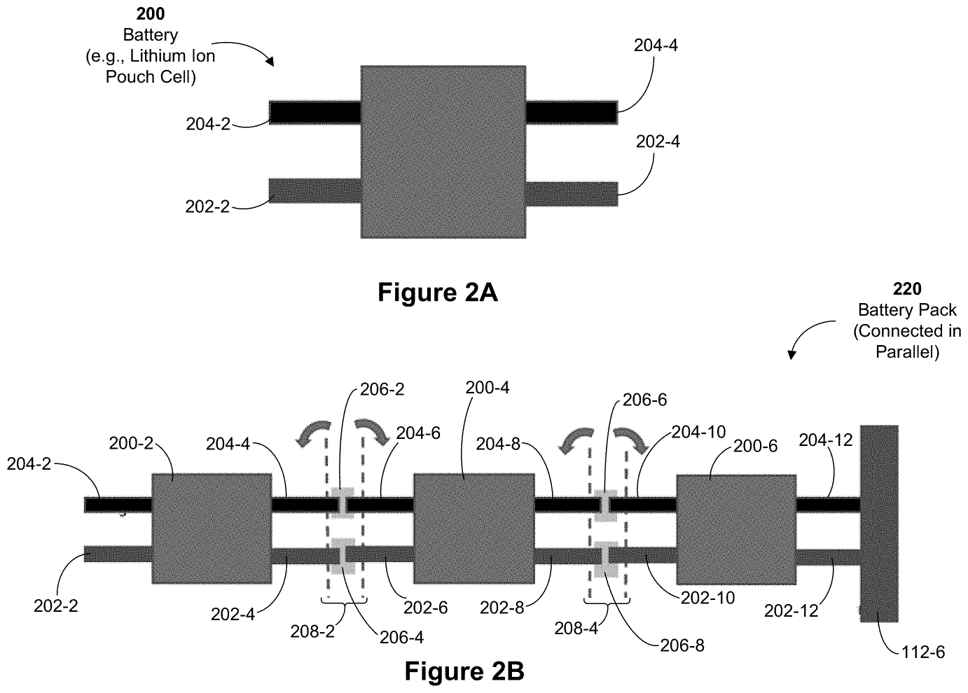

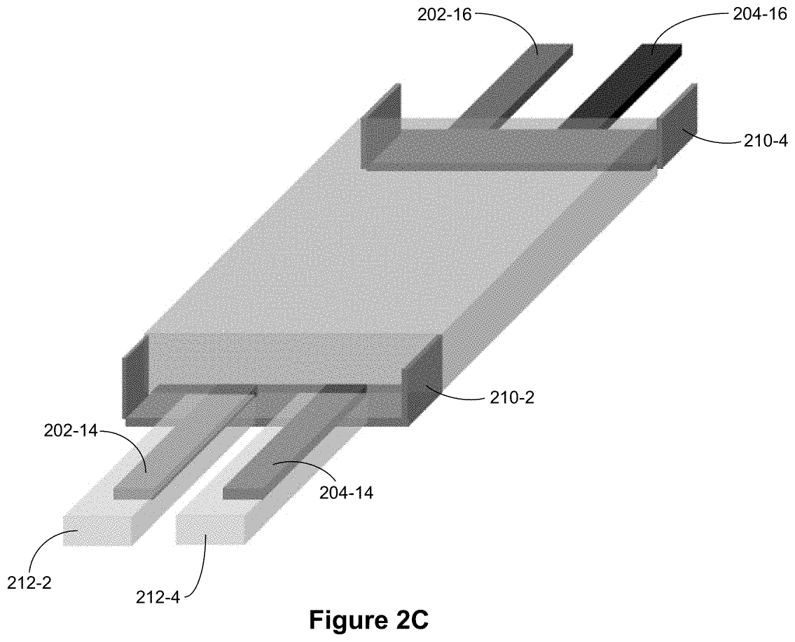

FIGS. 2A and 2B illustrate battery systems based on batteries with anode and cathode tabs extending from the sides, according to some implementations. Each battery cell 200 includes a pair of positive and negative tabs extending from each of two opposing sides. In FIG. 2A, the battery cell 200 has the positive terminals 202-2 and 202-4 and negative terminals 204-2 and 204-4 extending from opposing sides of the battery cell. The design of the battery cell 200 simplifies routing requirements when the battery cells are connected. FIG. 2B illustrates a 3P pack 220 using battery cells 200-2, 200-4, and 200-6, according to some implementations. Positive terminals 202-2 and 202-4, 202-6 and 202-8, and 202-10 and 202-12 come out on opposing sides of the respective cells 200-2, 200-4 and 200-6. Similarly, negative terminals 204-2 and 204-4, 204-6 and 204-8, and 204-10 and 204-12 come out on opposing sides of the respective cells 200-2, 200-4 and 200-6. This battery system 220 includes a plurality of battery cells connected in parallel.

Each battery cell also includes one or more pairs of adjacent joining pads. Each pair of adjacent joining pads electrically connects the respective positive and negative tabs of respective adjacent battery cells. The joining pads provide electrical connection, and, in some implementations, provide mechanical connection. In some implementations, a joining pad comprises a plurality of mechanically separate sub-pads that are electrically connected. For example, in FIG. 2B, the battery system 220 includes a first joining pad 206-2 connecting negative terminals 204-4 and 204-6, and a second joining pad 206-4 connecting positive terminals 202-4 and 202-6. The battery system 220 also includes a third joining pad 206-6 connecting negative terminals 204-8 and 204-10, and a fourth joining pad 206-8 connecting positive terminals 202-8 and 202-10.

As evident from the drawing, in contrast to FIGS. 1B and 1D, the battery design 200 entails simpler routing of the parallel connections, which reduces complexity in pack design. In addition, cells 200 with tabs on both sides can be manufactured with some modifications to existing mass manufacturing techniques. This design is very useful for battery packs in form-fitting situations such as VR headsets and body work accessories, where the battery has to fit around curved body features, such as a head, a wrist, or a neck. The interconnect regions 208-2 and 208-4 between cells are natural flex/bend points, enabling segmented cell structures, which can be curved for wearable applications. In some implementations, the battery cell 200 is used to build cuboidal battery packs or other form factor battery packs, such as curved, and other shapedbattery packs. The pouch containers (described above) are sometimes called cells. “Batteries” or “battery packs” consist of one or more cells, according to some implementations. The techniques described herein can be used to efficiently connect “cells” to make multi-cell “batteries.” The tab structure enables multi-cell battery systems that are curved. In addition, individual cells may be curved, terraced, or L-shaped. In some implementations, the battery cells have non-cuboidal shapes.

In some implementations, the positive tab and the negative tab corresponding to one side of a battery cell at one end of the parallel connection extend out on a terrace portion of the battery system. In some implementations, the battery system further includes a pair of bus-bars placed in the terrace portion. The pair of bus-bars includes a first bus-bar placed under the positive tab and a second bus-bar placed under the negative tab. FIG. 2C illustrates a terrace location in the cell architecture. The terrace can be efficiently used for the complete or partial placement of bus bars or PCB. In FIG. 2C, a first positive tab 202-14 and a first negative tab 204-14 extend on a first terrace portion 210-2, and a second positive tab 202-16 and a second negative tab 204-16 extend on a second terrace portion 210-4. FIG. 2C is a three dimensional diagram of a cell with bus bars 212-2 and 212-4 placed partially in the terrace area (under the positive tab 202-14 and under the negative tab 204-14, respectively).

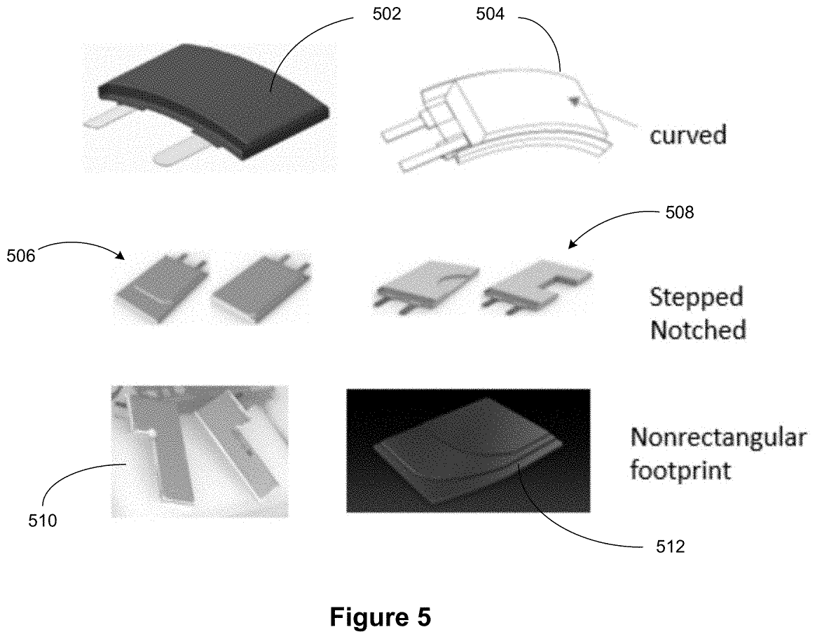

In some implementations, each joining pad (e.g., the pads 206-2, 206-4, 206-6, and 206-8 in FIG. 2B) is made of a flexible material so as to allow the respective positive and negative tabs of respective adjacent battery cells to bend around the respective joining pad (e.g., around the regions 208-2 and 208-4). In some implementations, the battery system is curved, and the joining pads define one or more contours of the battery system. Individual battery cells may be curved, terraced, or L-shaped (i.e., the shapes are not necessarily cuboidal). For example, FIG. 5 shows an L-shaped battery 510, and a non-rectangular battery 512, manufactured using the battery cell design described herein.

In some implementations, a battery cell at one end of the parallel connection is connected to a pack connector. For example, in FIG. 2B, the third battery cell 200-6 is connected to the pack connector 112-6. In some implementations, the battery system further comprises a first plurality of battery cells connected in parallel, and a second plurality of battery cells connected in parallel. For example, an additional set of 3 battery cells is connected in a manner similar to the three cells 200-2, 200-4, and 200-6 in FIG. 2B, and the additional set of battery cells is connected to the pack connector 112-6.

In some implementations, each joining pad is made of a respective conducting material that corresponds to the respective material of the respective positive or negative tabs. For example, in FIG. 2B, the first joining pad 206-2 is made of a conducting material that corresponds to the material of the negative tabs 204-4 and 204-6, the second joining pad 206-4 is made of a conducting material that corresponds to the material of the positive tabs 202-4 and 202-6, the third joining pad 206-6 is made of a conducting material that corresponds to the material of the negative tabs 204-8 and 204-10, and the fourth joining pad 206-8 is made of a conducting material that corresponds to the material of the positive tabs 202-8 and 202-10. In some implementations, all of the negative tabs are formed using a first material, whereas all of the positive tabs are formed using a second material, which is different from the first material.

It is noted that, although the tab architecture proposed in this disclosure is primarily aimed at parallel connections, cells with these tabs can be connected in parallel or in series. In other words, the cell tab architecture does not prevent serial connection of cells with these tabs.

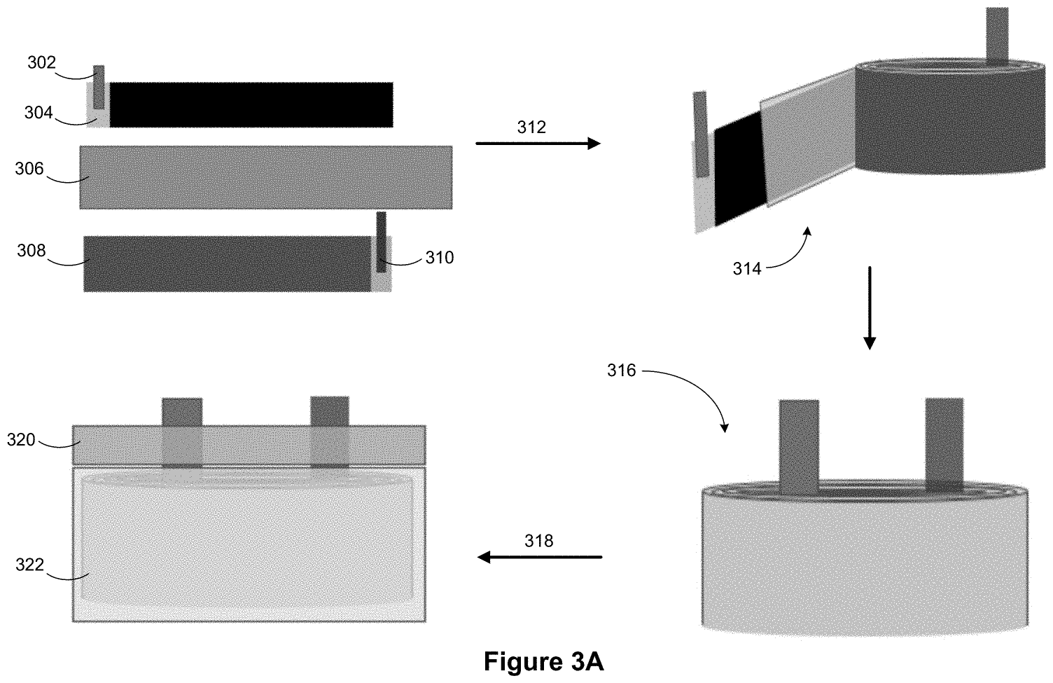

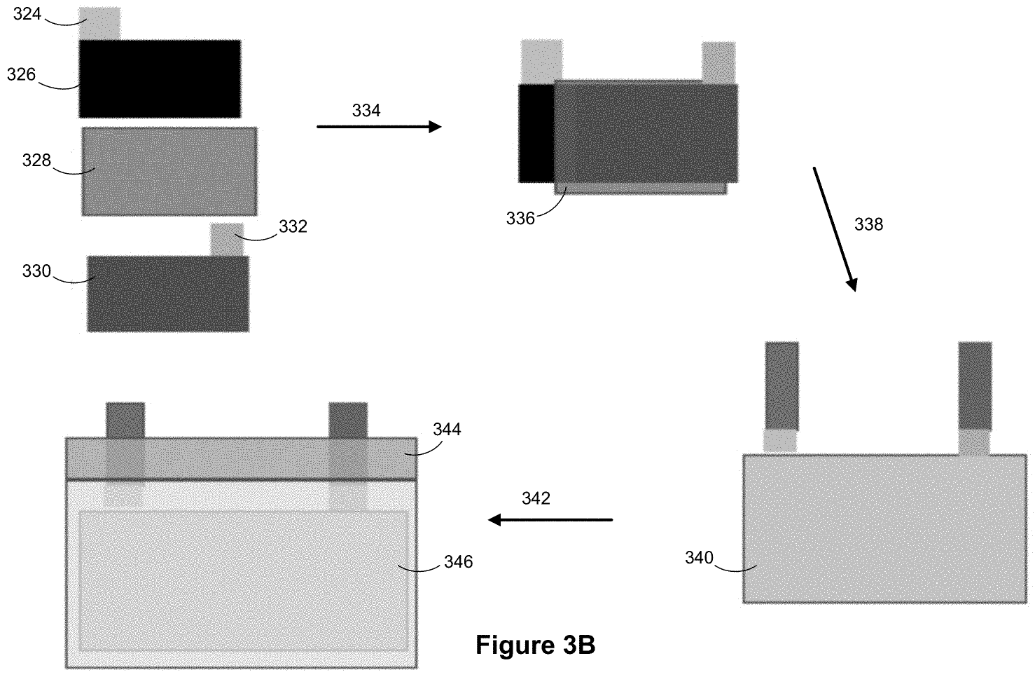

FIG. 3A illustrates a conventional process of manufacturing a battery by rolling. In FIG. 3A, a negative tab 302 extends from an anode strip 304. A separator strip 306 is also shown. A cathode strip 308 has a positive tab 310 at one end. The separator strip is placed over the anode strip, and the cathode strip is placed over the separator strip in the same orientation shown in FIG. 3A (i.e., the end portions where the tabs are attached extend away from each other), and the layers are wound (312) together. This results in the winding or a roll 314 with the positive tab 310 extending from the middle of the roll, and the negative tab 302 extending from the outer end of the roll. A complete winding results in a finished roll 316. The finished roll 316 is then packaged (318) in a pouch container 322 with pouch seals 320. In some implementations, the order of placement of the individual strips, and/or the orientation of the tabs are reversed, without impacting the functionality of the arrangement.

FIG. 3B illustrates a conventional process of manufacturing a battery by stacking. Similar to FIG. 3A, a negative tab 324 extends from each of a plurality of anode strips 326. A set of separator strips 328 is also shown. Each of a plurality of cathode strips 330 has a positive tab 332 at one end. Alternating layers of anode strip, separator strip, cathode strip, and separator strips are stacked (334) to obtain a stack of strips 336. The positive tab 332 and the negative tab 324 extend from one side of the stack 336. The tabs from individual layers are joined (338) together to obtain a finished cell stack 340. The finished cell stack 340 is then packaged (342) in a pouch container 346 with pouch seals 344.

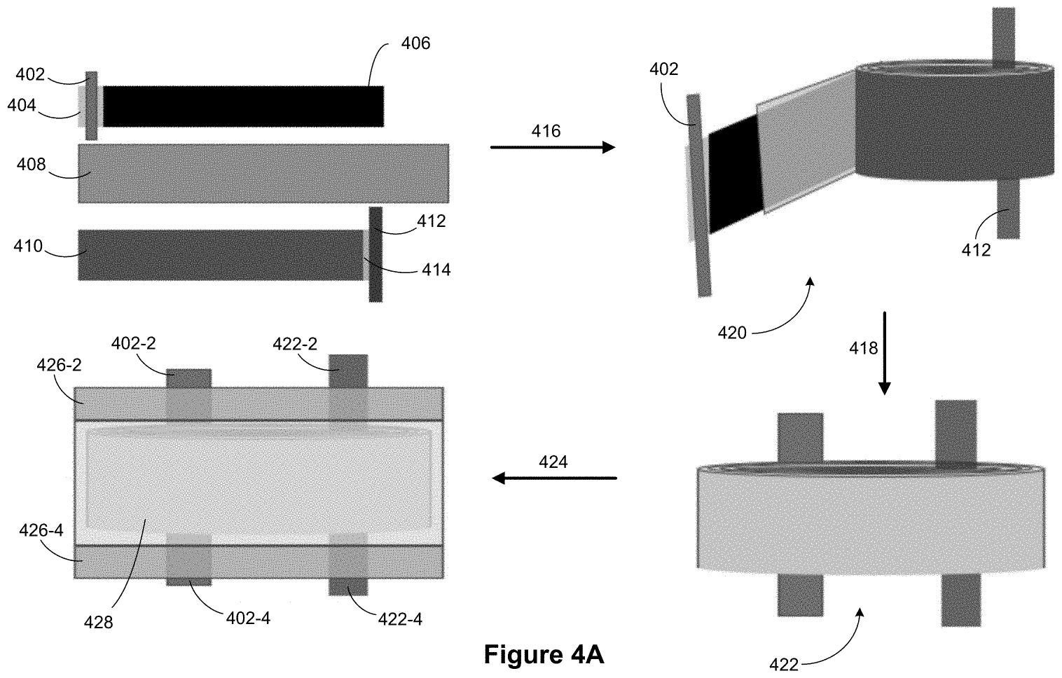

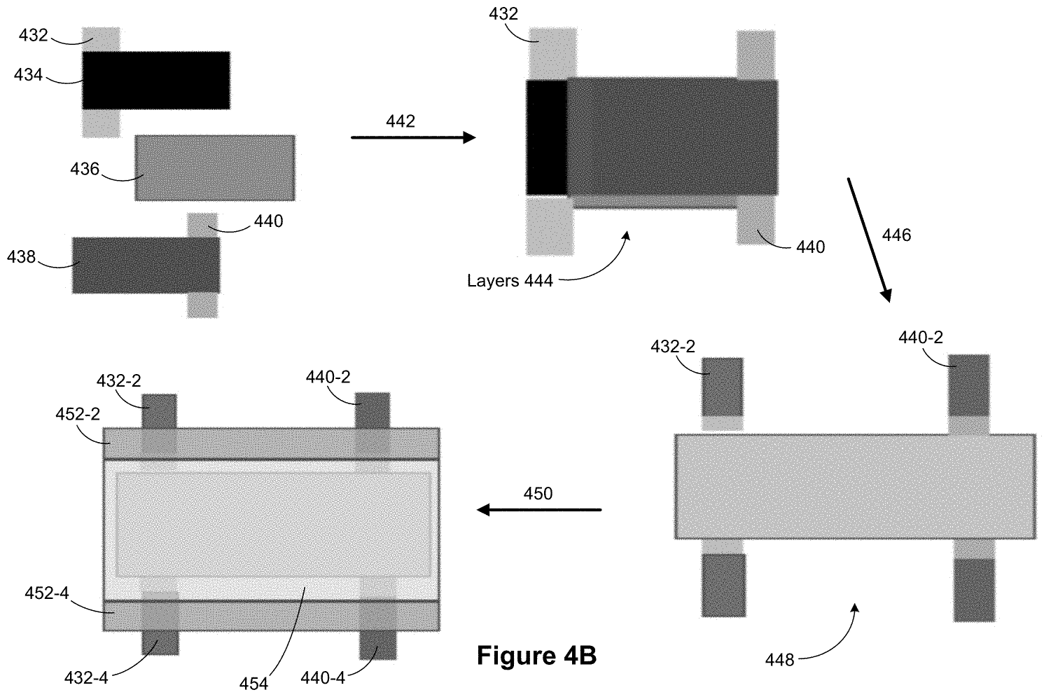

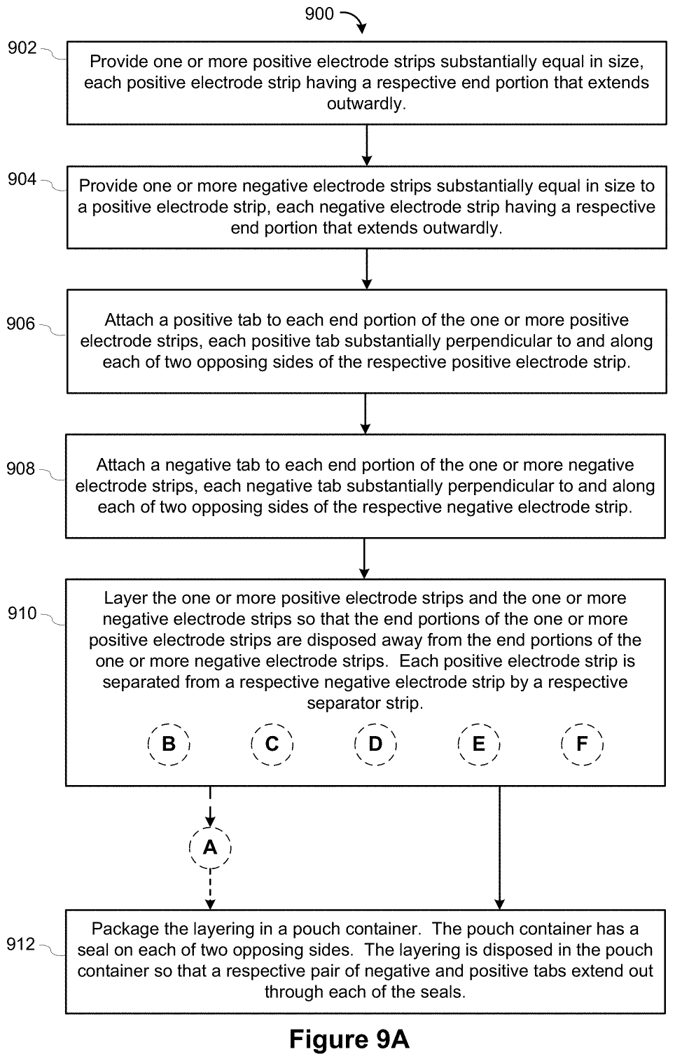

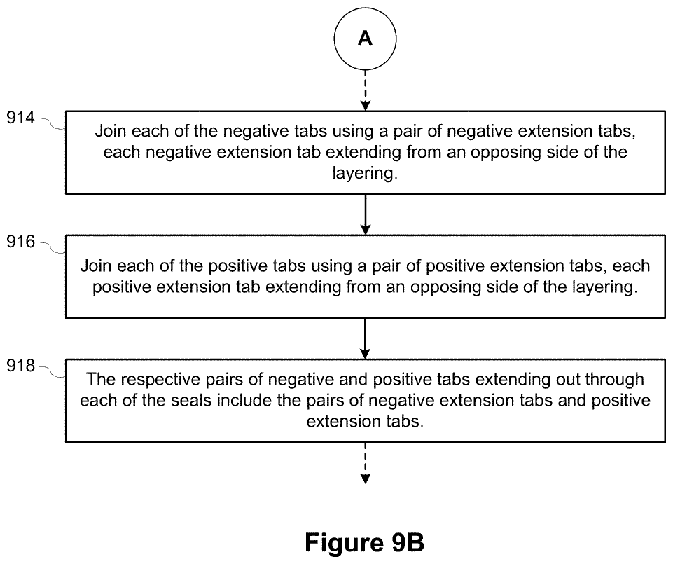

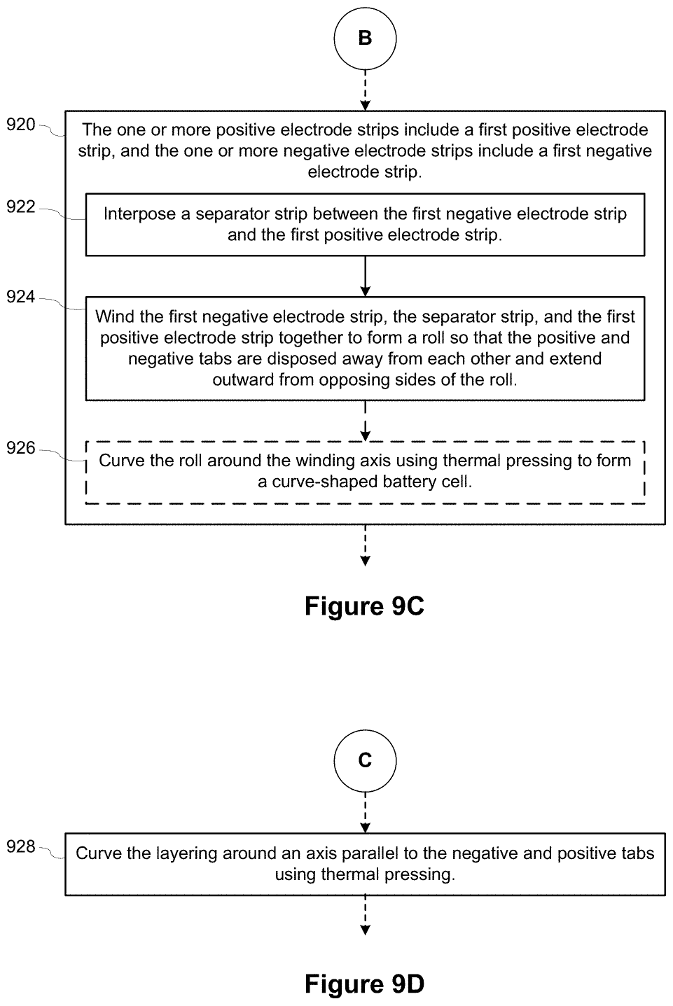

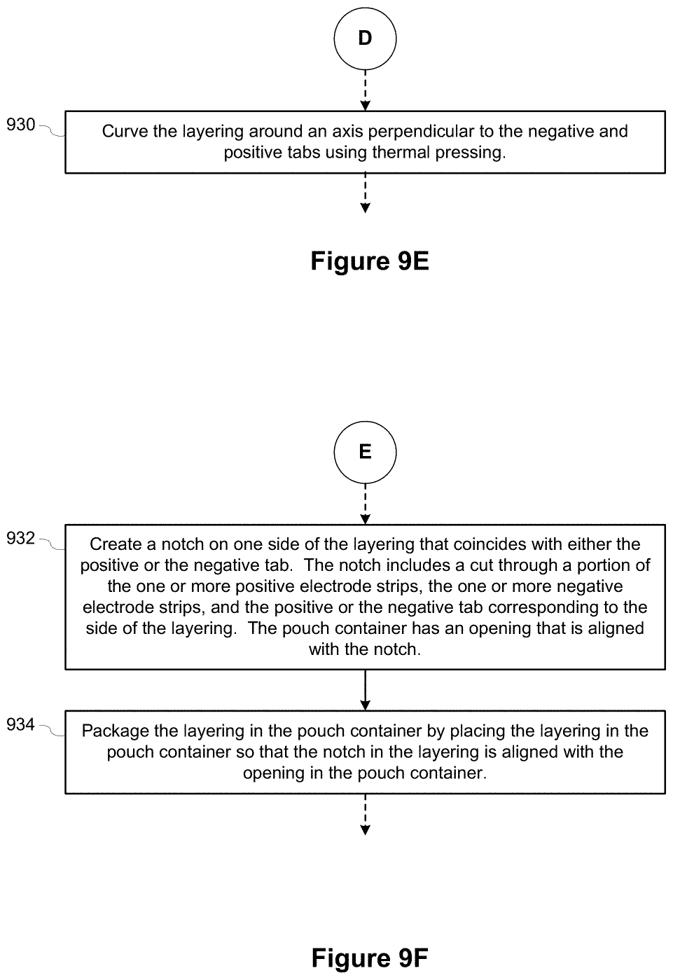

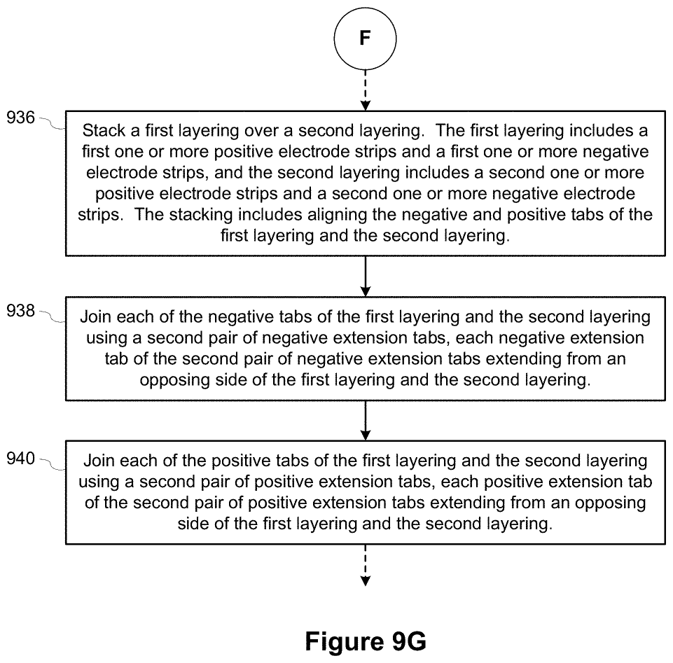

FIGS. 9A-9G provide a flowchart of a method 900 of manufacturing battery systems, according to some implementations. Method 900 is described in reference to FIGS. 4A and 4B, which illustrate adaptations of conventional manufacturing techniques of rolling and stacking for batteries with anode and cathode tabs extending from the sides, according to some implementations.

The method 900 includes providing (902) one or more positive electrode strips (e.g., the strips 410 in FIG. 4A and the strips 438 in FIG. 4B) substantially equal in size, each positive electrode strip having a respective end portion 414 that extends outwardly. The method also includes providing (904) one or more negative electrode strips (e.g., the strips 406 in FIG. 4A and the strips 434 in FIG. 4B) substantially equal in size to a positive electrode strip, each negative electrode strip having a respective end portion 404 that extends outwardly. The method further includes attaching (906) a positive tab (e.g., the tab 412 in FIG. 4A and the tab 440 in FIG. 4B) to each end portion of the one or more positive electrode strips. Each positive tab is substantially perpendicular to and extends along each of two opposing sides of the respective positive electrode strip, as illustrated in FIGS. 4A and 4B. The method also includes attaching (908) a negative tab (e.g., the tab 402 in FIG. 4A and the tab 432 in FIG. 4B) to each of the respective end portion (e.g., the portion 404) of the one or more negative electrode strips. Each negative tab is substantially perpendicular to and extends along each of two opposing sides of the respective negative electrode strip, as illustrated in FIGS. 4A and 4B.

The method 900 also includes layering (910) the one or more positive electrode strips and the one or more negative electrode strips so that the end portions of the one or more positive electrode strips are disposed away from the end portions of the one or more negative electrode strips. For example, in FIG. 4B, alternating layers of negative electrode strip 434, separator strip 436, and positive electrode strip 438 are stacked (442). Each positive electrode strip is separated from a respective negative electrode strip by a respective separator strip.

The method 900 further includes packaging (912) the layering (e.g., the roll 422 in FIG. 4A is packaged (424) and the stack 448 in FIG. 4B is packaged (450)) in a pouch container (e.g., the container 428 in FIG. 4A, and the container 454 in FIG. 4B). The pouch container has a seal on at least two opposing sides. For example, in FIG. 4A, container 428 has the seals 426-2 and 426-4, and, in FIG. 4B, the container 454 has the seals 452-2 and 452-4. Each seal closes (or proofs) each of two opposing sides of the respective containers. The layering is disposed in the pouch container so that a respective pair of negative and positive tabs extend out through at least two of the seals. For example, in FIG. 4A, negative extension tabs 402-2 and 402-4 and positive extension tabs 422-2 and 422-4 extend on opposing sides of the container pouch 428 through the seals 426-2 and 426-4. Similarly, in FIG. 4B, negative extension tabs 432-2 and 432-4 and positive extension tabs 440-2 and 440-4 extend on opposing sides of the container pouch 454 through the seals 452-2 and 452-4.

Referring next to FIG. 9B, in some implementations, the method 900 further includes joining (914) each of the negative tabs using a pair of negative extension tabs, each negative extension tab extending from an opposing side of the layering, and joining (916) each of the positive tabs using a pair of positive extension tabs, each positive extension tab extending from an opposing side of the layering. The respective pairs of negative and positive tabs extending out through each of the seals include (918) the pairs of negative extension tabs and positive extension tabs. For example, in FIG. 4B, the tabs 432 and 440 from individual layers 444 are joined together (446) using tab extensions (e.g., the tab extensions 432-2 and 440-2) to obtain a finished cell stack 448 which is then packaged (450) in the pouch container 454.

Referring next to FIG. 9C, in some implementations, the one or more positive electrode strips include (920) a first positive electrode strip, and the one or more negative electrode strips includes a first negative electrode strip. The method 900 includes layering the one or more positive electrode strips and the one or more negative electrode strips by interposing (922) a separator strip between the first negative electrode strip and the first positive electrode strip, and winding (924) the first negative electrode strip, the separator strip, and the first positive electrode strip together to form a roll so that the positive and negative tabs are disposed away from each other and extend outward from opposing sides of the roll. For example, in FIG. 4A, the negative electrode strip 406, the separator strip 408, and the positive electrode strip 410 are rolled or wound (416) together to form a roll 420. A complete winding of the roll creates (418) a finished roll 422 which is then packaged (424) in a pouch container 428.

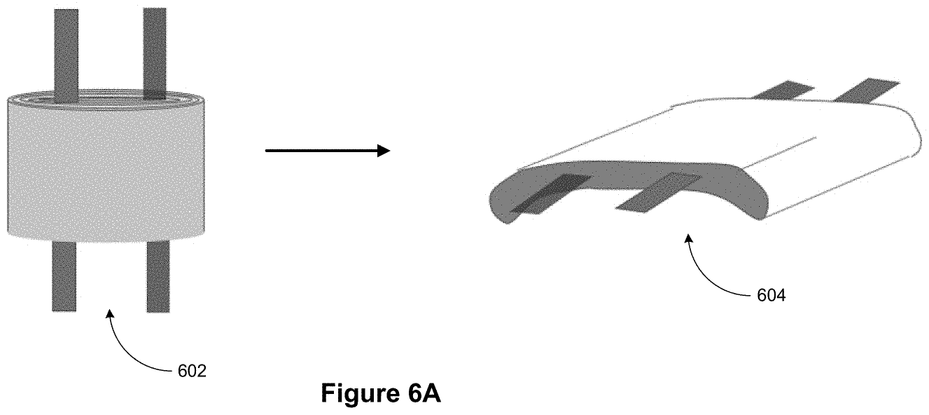

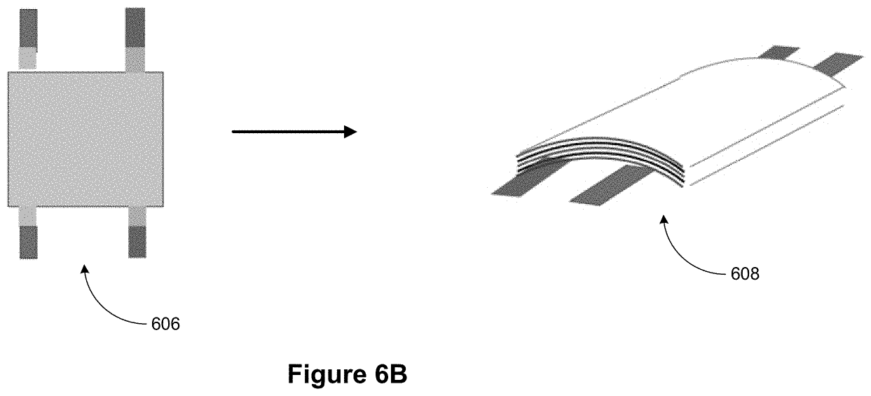

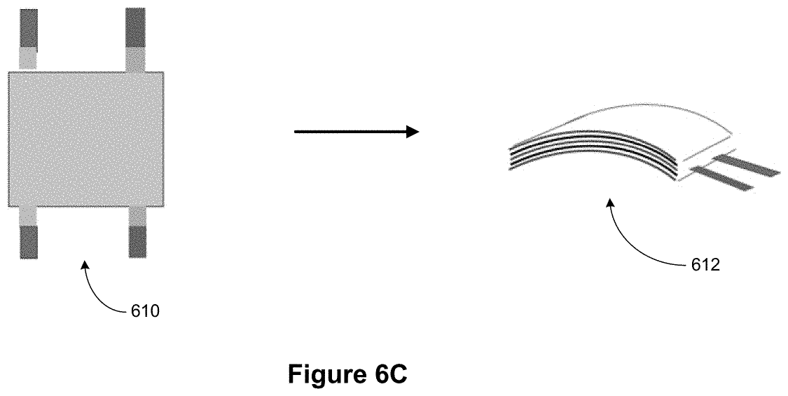

In some implementations, the method 900 further includes curving (926) the roll around the winding axis using thermal pressing (e.g., by applying heat) to form a curve-shaped battery cell. FIG. 5 shows an example of a curve-shaped battery 502. FIG. 6A illustrates this process of curving a roll 602 around the winding axis of the roll, which results in the curved battery structure 604.

Referring next to FIG. 9D, in some implementations, the method 900 further includes curving the layering around an axis parallel to the negative and positive tabs using thermal pressing. FIG. 6B illustrates this process of curving (928) layering 606 around an axis parallel to the tabs to create the battery structure 608.

Referring next to FIG. 9E, in some implementations, the method 900 further includes curving (930) the layering around an axis perpendicular to the negative and positive tabs using thermal pressing. FIG. 5 shows an example of a curve-shaped battery 504. FIG. 6C illustrates this process of curving layering 610 around an axis perpendicular to the negative and positive tabs to create the battery structure 612.

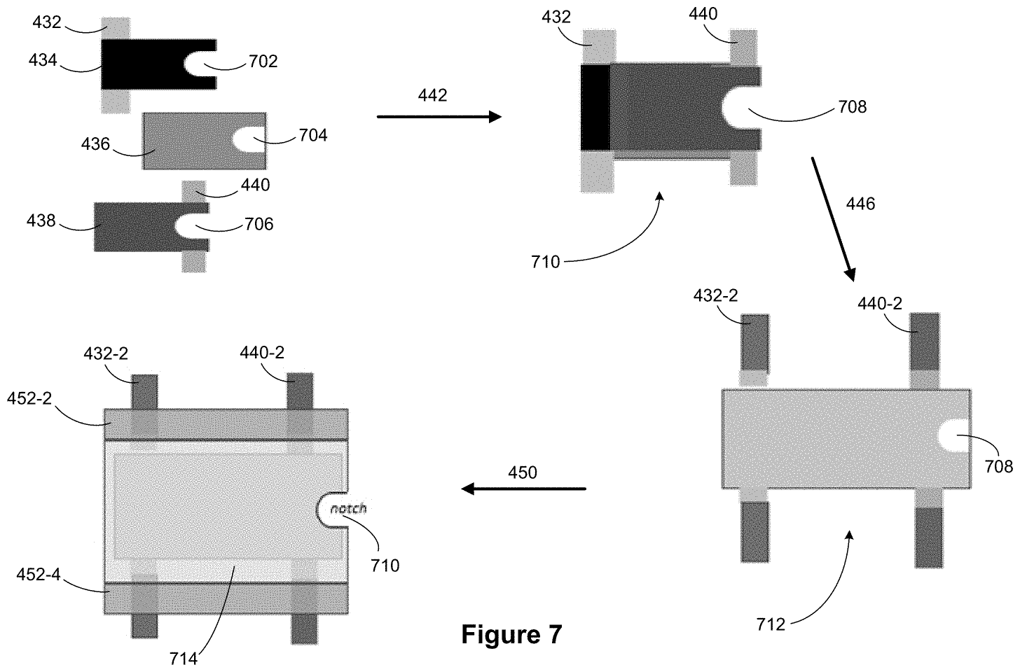

Referring next to FIG. 9F, in some implementations, the method 900 further includes creating (932) a notch on one side of the layering that coincides with either the positive or the negative tab. The notch includes a cut through a portion of the one or more positive electrode strips and through the one or more negative electrode strips. In some implementations, the notch includes a cut through the separator strips between the electrode strips. In some implementations, the notch includes a cut through the positive or the negative tab corresponding to the side of the layering. The pouch container has an opening that is aligned with the notch. The method 900 also includes packaging (934) the layering in the pouch container by placing the layering in the pouch container so that the notch in the layering is aligned with the opening in the pouch container. FIG. 7 illustrates a stacked battery system with a notch, according to some implementations. FIG. 7 is similar to FIG. 4B, as indicated by similar reference characters of the parts and the processes, so only the relevant new elements are discussed here. Each of the anode strips 434 is notched (702), each of the cathode strips 438 is notched (706), and the separator strips 436 are notched (704). Layering or stacking the strips results in the stack 710 with the aligned notch 708. The tabs are joined (e.g., using the extension tabs 432-2 and 440-2) to result in a finished cell stack 712 with the notch 708. The finished cell stack 712 is packaged (450) in a pouch container 714 having an opening 710 for the notch 708. FIG. 5 shows examples of stepped, or notched batteries 508.

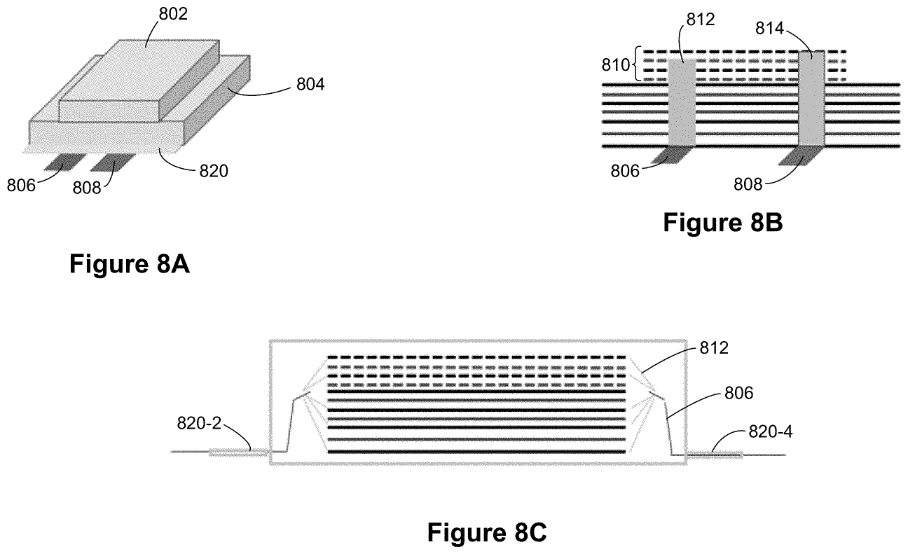

Referring next to FIG. 9G, in some implementations, the method 900 further includes stacking (936) a first layering over a second layering. The first layering includes (936) a first set of one or more positive electrode strips and a first set of one or more negative electrode strips. The second layering includes (936) a second set of one or more positive electrode strips and a second set of one or more negative electrode strips. The stacking includes (936) aligning the negative and positive tabs of the first layering and the second layering. For example, in FIG. 8A, a first layer 802 is stacked above a second layer 804 so that the respective cathode strips (e.g., the positive tabs 806) and the anode strips (e.g., the negative tabs 808) are aligned. Although not shown, a second set of tabs protrudes from back side of the cell. The tabs for the cell extend through the seal 820 as explained above in reference to FIGS. 4A and 4B.

The method 900 also includes joining (938) each of the negative tabs of the first layering and the second layering using a second pair of negative extension tabs. Each negative extension tab of the second pair of negative extension tabs extends (938) from an opposing side of the first layering and the second layering. The method 900 further includes joining (940) each of the positive tabs of the first layering and the second layering using a second pair of positive extension tabs. Each positive extension tab of the second pair of positive extension tabs extends (940) from an opposing side of the first layering and the second layering. FIGS. 8B and 8C illustrate these steps 938 and 940, according to some implementations. FIG. 8B is a two-dimensional front-side view of the cell shown in FIG. 8A. The top terrace electrodes (for layer 802) are shown as dashed lines 810. Tabs from all negative electrode layers 806 are attached (e.g., welded) to the negative tab extension 812, and tabs from all positive electrode layers 808 are attached (e.g., welded) to the positive tab extension 814. The tabs from the layers are aligned so as to be attached. FIG. 8C is a two-dimensional side-view of the cell shown in FIG. 8A with the attachments or extensions shown in FIG. 8B. Tabs extend through seals 820-2 and 820-4 from the front-side and the back-side portions of the cell, respectively. FIG. 5 shows examples of stepped, or layered batteries 506 or 508 made using the techniques described and illustrated by FIGS. 8A-8C and 9G.

In another aspect, a battery system has one or more positive electrode strips substantially equal in size. Each positive electrode strip has a respective end portion that extends outwardly, according to some implementations. The battery system also includes one or more negative electrode strips substantially equal in size to the positive electrode strips. Each negative electrode strip has a respective end portion that extends outwardly. The battery system also includes a pouch container having a seal on at least two opposing sides. The battery system is manufactured as described above in reference to the flowchart 900 in FIGS. 9A-9G, according to some implementations. Examples of battery systems are illustrated above in FIGS. 2A-2C, 3A-3B, 4A-4B, 5, 6A-6C, 7, and 8A-8C.

The method of manufacturing includes attaching a positive tab to each end portion of the one or more positive electrode strips. Each positive tab is substantially perpendicular to and extends along each of two opposing sides of the respective positive electrode strip. The method of manufacturing also includes attaching a negative tab to each end portion of the one or more negative electrode strips. Each negative tab is substantially perpendicular to and extends along each of two opposing sides of the respective negative electrode strip. The method of manufacturing also includes layering the one or more positive electrode strips and the one or more negative electrode strips so that the end portions of the one or more positive electrode strips are disposed away from the end portions of the one or more negative electrode strips. Each positive electrode strip is separated from a respective negative electrode strip by a respective separator strip. The method of manufacturing also includes packaging the layering in a pouch container. The layering is disposed in the pouch container so that a respective pair of negative and positive tabs extend out through each of the seals.

Although not shown, in another aspect, a battery system is provided that includes a plurality of battery cells connected in parallel. Each battery cell includes a pair of positive and negative tabs extending from each of two opposing sides. The respective positive tabs of respective adjacent battery cells are electrically connected, and the respective negative tabs of respective adjacent battery cells are electrically connected.

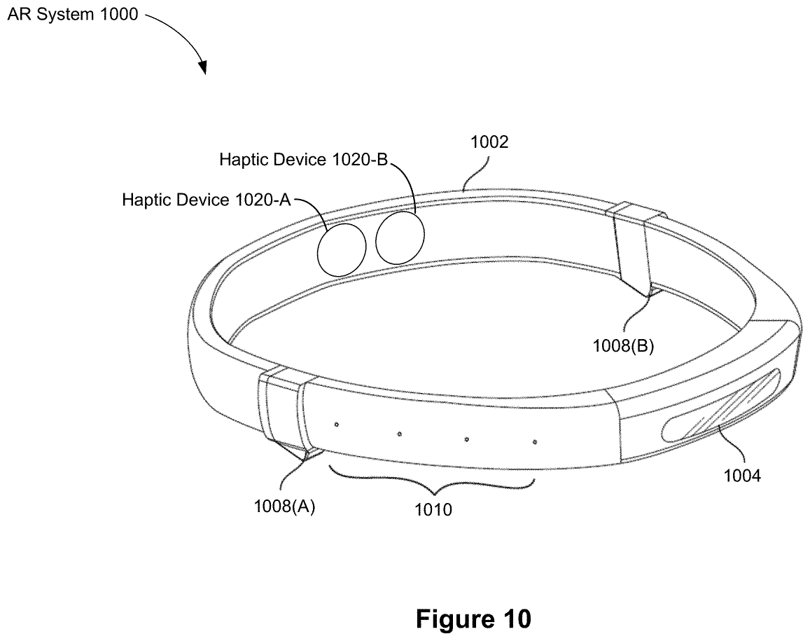

FIGS. 10-12 provide examples of artificial reality devices that may utilize battery pack embodiments described herein. The AR system 1000 in FIG. 10 generally represents a wearable device dimensioned to fit about a body part (e.g., a head) of a user. The AR system 1000 may include the functionality of a wearable device, and may include additional functions not described above. As shown, the AR system 1000 includes a frame 1002 (e.g., band) and a camera assembly 1004, which is coupled to the frame 1002 and configured to gather information about a local environment by observing the local environment. The AR system 1000 may also include one or more transducers. In one example, the AR system 1000 includes output transducers 1008(A) and 1008(B) and input transducers 1010. The output transducers 1008(A) and 1008(B) may provide audio feedback, haptic feedback, and/or content to a user, and input audio transducers may capture audio (or other signals/waves) in a user's environment.

In some embodiments, the AR system 1000 includes one or more instances of haptic devices 1020 (e.g., the haptic devices 1020-A and 1020-B). In this way, the AR system 1000 is able to create haptic stimulations.

The AR system 1000 does not include a near-eye display (NED) positioned in front of a user's eyes. AR systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the AR system 1000 may not include an NED, the AR system 1000 may include other types of screens or visual feedback devices (e.g., a display screen integrated into a side of the frame 1002).

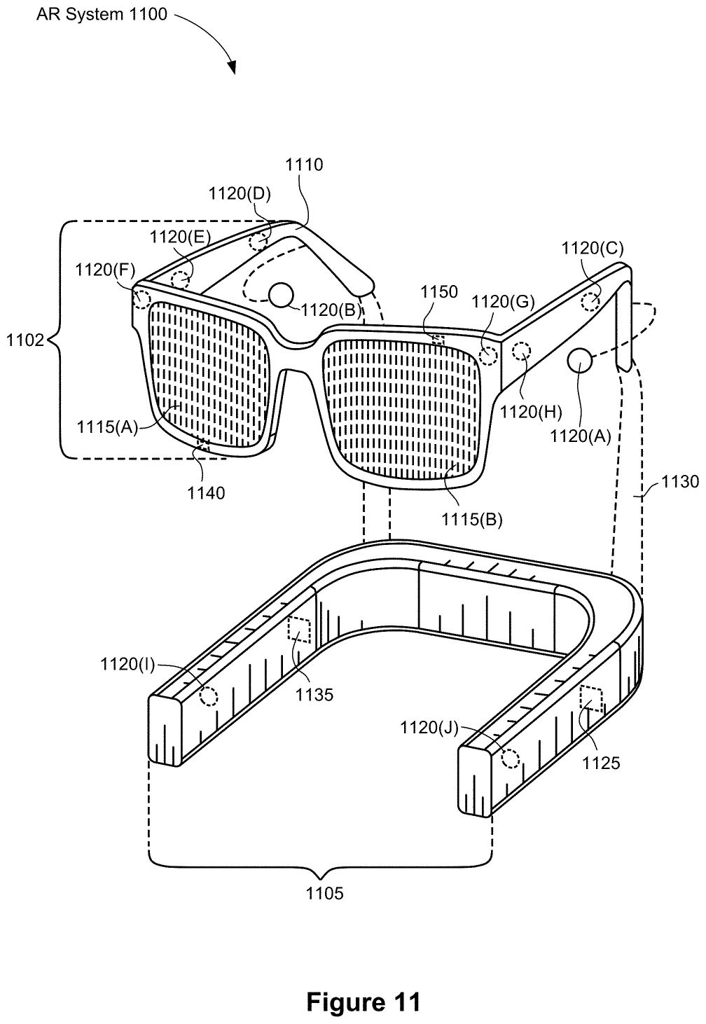

The embodiments discussed in this disclosure may also be implemented in AR systems that include one or more NEDs. For example, as shown in FIG. 11, the AR system 1100 may include an eyewear device 1102 with a frame 1110 configured to hold a right display device 1115(A) and a left display device 1115(B) in front of a user's eyes. The display devices 1115(A) and 1115(B) may act together or independently to present an image or series of images to a user. While the AR system 1100 includes two displays, embodiments of this disclosure may be implemented in AR systems with a single NED or more than two NEDs.

In some embodiments, the AR system 1100 may include one or more sensors, such as the sensors 1140 and 1150. The sensors 1140 and 1150 may generate measurement signals in response to motion of the AR system 1100 and may be located on substantially any portion of frame 1110. The sensors 1140 and 1150 may include a position sensor, an inertial measurement unit (IMU), a depth camera assembly, or any combination thereof. The AR system 1100 may or may not include sensors or may include more than one sensor. In embodiments in which the sensor 1140 or the sensor 1150 is an IMU, the IMU may generate calibration data based on measurement signals from the sensor. Examples of the sensors 1140 and 1150 include, without limitation, accelerometers, gyroscopes, magnetometers, other suitable types of sensors that detect motion, sensors used for error correction of the IMU, or some combination thereof.

The AR system 1100 may also include a microphone array with a plurality of acoustic sensors 1120(A)-1120(J), referred to collectively as the acoustic sensors 1120. The acoustic sensors 1120 may be transducers that detect air pressure variations induced by sound waves. Each acoustic sensor 1120 may be configured to detect sound and convert the detected sound into an electronic format (e.g., an analog or digital format). The microphone array in FIG. 11 may include, for example, ten acoustic sensors: 1120(A) and 1120(B), which may be designed to be placed inside a corresponding ear of the user, acoustic sensors 1120(C), 1120(D), 1120(E), 1120(F), 1120(G), and 1120(H), which may be positioned at various locations on the frame 1110, and/or acoustic sensors 1120(I) and 1120(J), which may be positioned on a corresponding neckband 1105. In some embodiments, the neckband 1105 is a computer system.

The configuration of acoustic sensors 1120 of the microphone array may vary. While the AR system 1100 is shown in FIG. 11 as having ten acoustic sensors 1120, the number of acoustic sensors 1120 may be greater or less than ten. In some embodiments, using more acoustic sensors 1120 may increase the amount of audio information collected and/or the sensitivity and accuracy of the audio information. In contrast, using fewer acoustic sensors 1120 may decrease the computing power required by a controller 1125 to process the collected audio information. In addition, the position of each acoustic sensor 1120 of the microphone array may vary. For example, the position of an acoustic sensor 1120 may include a defined position on the user, a defined coordinate on the frame 1110, an orientation associated with each acoustic sensor, or some combination thereof.

The acoustic sensors 1120(A) and 1120(B) may be positioned on different parts of the user's ear, such as behind the pinna or within the auricle or fossa. Or, there may be additional acoustic sensors on or surrounding the ear in addition to acoustic sensors 1120 inside the ear canal. Having an acoustic sensor positioned next to an ear canal of a user may enable the microphone array to collect information on how sounds arrive at the ear canal. By positioning at least two of the acoustic sensors 1120 on either side of a user's head (e.g., as binaural microphones), the AR device 1100 may simulate binaural hearing and capture a 3D stereo sound field around about a user's head. In some embodiments, the acoustic sensors 1120(A) and 1120(B) may be connected to the AR system 1100 via a wired connection, and in other embodiments, the acoustic sensors 1120(A) and 1120(B) may be connected to the AR system 1100 via a wireless connection (e.g., a Bluetooth connection). In still other embodiments, acoustic sensors 1120(A) and 1120(B) may not be used at all in conjunction with the AR system 1100.

The acoustic sensors 1120 on the frame 1110 may be positioned along the length of the temples, across the bridge, above or below the display devices 1115(A) and 1115(B), or some combination thereof. The acoustic sensors 1120 may be oriented such that the microphone array is able to detect sounds in a wide range of directions surrounding the user wearing AR system 1100. In some embodiments, an optimization process may be performed during manufacturing of AR system 1100 to determine relative positioning of each acoustic sensor 1120 in the microphone array.

The AR system 1100 may further include or be connected to an external device (e.g., a paired device), such as a neckband 1105. As shown, the neckband 1105 may be coupled to the eyewear device 1102 via one or more connectors 1130. The connectors 1130 may be wired or wireless connectors and may include electrical and/or non-electrical (e.g., structural) components. In some cases, the eyewear device 1102 and the neckband 1105 may operate independently without any wired or wireless connection between them. While FIG. 11 illustrates the components of the eyewear device 1102 and the neckband 1105 in example locations on the eyewear device 1102 and the neckband 1105, the components may be located elsewhere and/or distributed differently on the eyewear device 1102 and/or the neckband 1105. In some embodiments, the components of the eyewear device 1102 and the neckband 1105 may be located on one or more additional peripheral devices paired with the eyewear device 1102, the neckband 1105, or some combination thereof. Furthermore, the neckband 1105 generally represents any type or form of paired device. Thus, the following discussion of neckband 1105 may also apply to various other paired devices, such as smart watches, smart phones, wrist bands, other wearable devices, hand-held controllers, tablet computers, or laptop computers.

Pairing external devices, such as a neckband 1105, with AR eyewear devices may enable the eyewear devices to achieve the form factor of a pair of glasses while still providing sufficient battery and computation power for expanded capabilities. Some or all of the battery power, computational resources, and/or additional features of the AR system 1100 may be provided by a paired device or shared between a paired device and an eyewear device, thus reducing the weight, heat profile, and form factor of the eyewear device overall while still retaining desired functionality. For example, the neckband 1105 may allow components that would otherwise be included on an eyewear device to be included in the neckband 1105 because users may tolerate a heavier weight load on their shoulders than they would tolerate on their heads. The neckband 1105 may also have a larger surface area over which to diffuse and disperse heat to the ambient environment. Thus, the neckband 1105 may allow for greater battery and computation capacity than might otherwise have been possible on a stand-alone eyewear device. Because weight carried in the neckband 1105 may be less invasive to a user than weight carried in the eyewear device 1102, a user may tolerate wearing a lighter eyewear device and carrying or wearing the paired device for greater lengths of time than the user would tolerate wearing a heavy standalone eyewear device, thereby enabling an artificial reality environment to be incorporated more fully into a user's day-to-day activities.

The neckband 1105 may be communicatively coupled with the eyewear device 1102 and/or to other devices. The other devices may provide certain functions (e.g., tracking, localizing, depth mapping, processing, storage, etc.) to the AR system 1100. In the embodiment of FIG. 11, the neckband 1105 may include two acoustic sensors 1120(I) and 1120(J), which are part of the microphone array (or potentially form their own microphone subarray). The neckband 1105 may also include a controller 1125 and a power source 1135.

The acoustic sensors 1120(I) and 1120(J) of the neckband 1105 may be configured to detect sound and convert the detected sound into an electronic format (analog or digital). In the embodiment of FIG. 11, the acoustic sensors 1120(I) and 1120(J) may be positioned on the neckband 1105, thereby increasing the distance between neckband acoustic sensors 1120(I) and 1120(J) and the other acoustic sensors 1120 positioned on the eyewear device 1102. In some cases, increasing the distance between the acoustic sensors 1120 of the microphone array may improve the accuracy of beamforming performed via the microphone array. For example, if a sound is detected by the acoustic sensors 1120(C) and 1120(D) and the distance between acoustic sensors 1120(C) and 1120(D) is greater than, for example, the distance between the acoustic sensors 1120(D) and 1120(E), the determined source location of the detected sound may be more accurate than if the sound had been detected by the acoustic sensors 1120(D) and 1120(E).

The controller 1125 of the neckband 1105 may process information generated by the sensors on the neckband 1105 and/or the AR system 1100. For example, the controller 1125 may process information from the microphone array, which describes sounds detected by the microphone array. For each detected sound, the controller 1125 may perform a direction of arrival (DOA) estimation to estimate a direction from which the detected sound arrived at the microphone array. As the microphone array detects sounds, the controller 1125 may populate an audio data set with the information. In embodiments in which the AR system 1100 includes an IMU, the controller 1125 may compute all inertial and spatial calculations from the IMU located on the eyewear device 1102. The connector 1130 may convey information between the AR system 1100 and the neckband 1105 and between the AR system 1100 and the controller 1125. The information may be in the form of optical data, electrical data, wireless data, or any other transmittable data form. Moving the processing of information generated by the AR system 1100 to the neckband 1105 may reduce weight and heat in the eyewear device 1102, making it more comfortable to a user.

The power source 1135 in the neckband 1105 may provide power to the eyewear device 1102 and/or to the neckband 1105. The power source 1135 may include, without limitation, lithium-ion batteries, lithium-polymer batteries, primary lithium batteries, alkaline batteries, or any other form of power storage. In some cases, the power source 1135 may be a wired power source. Including the power source 1135 on the neckband 1105 instead of on the eyewear device 1102 may help better distribute the weight and heat generated by the power source 1135.

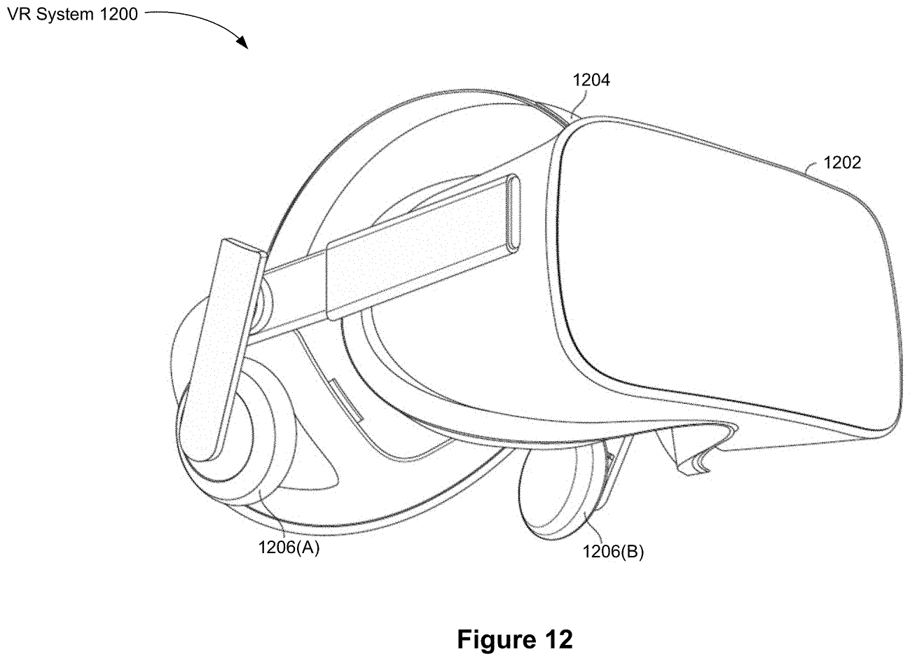

As noted, some artificial reality systems may, instead of blending an artificial reality with actual reality, substantially replace one or more of a user's sensory perceptions of the real world with a virtual experience. One example of this type of system is a head-worn display system, such as the VR system 1200 in FIG. 12, which mostly or completely covers a user's field of view. the VR system 1200 may include a front rigid body 1202 and a band 1204 shaped to fit around a user's head. The VR system 1200 may also include output audio transducers 1206(A) and 1206(B). Furthermore, while not shown in FIG. 12, the front rigid body 1202 may include one or more electronic elements, including one or more electronic displays, one or more IMUs, one or more tracking emitters or detectors, and/or any other suitable device or system for creating an artificial reality experience. Although not shown, the VR system 1200 may include a computer system.

Artificial reality systems may include a variety of types of visual feedback mechanisms. For example, display devices in the AR system 1100 and/or the VR system 1200 may include one or more liquid-crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems also include optical subsystems having one or more lenses (e.g., conventional concave or convex lenses, Fresnel lenses, or adjustable liquid lenses) through which a user may view a display screen.

In addition to or instead of using display screens, some artificial reality systems include one or more projection systems. For example, display devices in the AR system 1100 and/or the VR system 1200 may include micro-LED projectors that project light (e.g., using a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, the AR system 1000, the AR system 1100, and/or the VR system 1200 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 10 and 12, the output audio transducers 1008(A), 1008(B), 1206(A), and 1206(B) may include voice coil speakers, ribbon speakers, electrostatic speakers, piezoelectric speakers, bone conduction transducers, cartilage conduction transducers, and/or any other suitable type or form of audio transducer. Similarly, the input audio transducers 1010 may include condenser microphones, dynamic microphones, ribbon microphones, and/or any other type or form of input transducer. In some embodiments, a single transducer may be used for both audio input and audio output.

The artificial reality systems shown in FIGS. 10-12 may include tactile (i.e., haptic) feedback systems, which may be incorporated into headwear, gloves, body suits, handheld controllers, environmental devices (e.g., chairs or floor mats), and/or any other type of device or system, such as a wearable device. Additionally, in some embodiments, the haptic feedback systems may be incorporated with the artificial reality systems (e.g., the AR system 1000 may include the haptic devices 1020-A and 1020-B). Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independently of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, or business enterprises), entertainment purposes (e.g., for playing video games, listening to music, or watching video content), and/or for accessibility purposes (e.g., as hearing aids or vision aids). The embodiments disclosed herein may enable or enhance a user's artificial reality experience in one or more of these contexts and environments and/or in other contexts and environments.

Embodiments of this disclosure may include or be implemented in conjunction with various types of artificial reality systems. Artificial reality may constitute a form of reality that has been altered by virtual objects for presentation to a user. Such artificial reality may include and/or represent VR, AR, MR, hybrid reality, or some combination and/or variation of one or more of the these. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used to, for example, create content in an artificial reality and/or are otherwise used in (e.g., to perform activities in) an artificial reality.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

1. A battery system, comprising:
a plurality of battery cells connected in parallel, each battery cell including a pair of positive tabs and a pair of negative tabs, with the tabs in each pair on two opposite surfaces, extending outward in opposite directions from each of the two opposite surfaces; and
a plurality of positive joining pads and a plurality of negative joining pads, wherein (i) each positive joining pad electrically connects respective positive tabs of respective adjacent battery cells and (ii) each negative joining pad electrically connects respective negative tabs of respective adjacent battery cells.

2. The battery system of claim 1, wherein a first end of a first battery cell includes a terrace portion, and a first positive tab and a first negative tab, corresponding to the first end of the first battery cell, extend out onto the terrace portion.

3. The battery system of claim 2, further comprising a pair of bus-bars placed in the terrace portion, the pair of bus-bars including a first bus-bar placed under the first positive tab and a second bus-bar placed under the first negative tab.

4. The battery system of claim 1, wherein each joining pad is made of a flexible material so as to allow the respective positive and negative tabs of respective adjacent battery cells to bend radially around the respective joining pad.

5. The battery system of claim 4, wherein the battery system has a shape that is curved, and a plurality of the joining pads define one or more contours of the shape of the battery system.

6. The battery system of claim 1, further comprising a first plurality of battery cells connected in parallel, and a second plurality of battery cells connected in parallel.

7. The battery system of claim 1, wherein each joining pad is made of a respective conducting material that corresponds to a respective material of the positive or negative tabs connected by the respective joining pad.

8. The battery system of claim 1, wherein a battery cell at one end of the parallel connection is connected to a pack connector.

9. The battery system of claim 1, wherein (i) the respective positive joining pad mechanically or physically connects the respective positive tabs of respective adjacent battery cells and (ii) the respective negative joining pad mechanically or physically connects the respective negative tabs of respective adjacent battery cells.

10. A method of manufacturing a battery, the method comprising:
providing one or more positive electrode strips substantially equal in size, each positive electrode strip having a respective end portion that extends outwardly;
providing one or more negative electrode strips substantially equal in size to the positive electrode strips, each negative electrode strip having a respective end portion that extends outwardly;
attaching a positive tab to each end portion of the one or more positive electrode strips, each positive tab substantially perpendicular to and along each of two opposing sides of the respective positive electrode strip;
attaching a negative tab to each end portion of the one or more negative electrode strips, each negative tab substantially perpendicular to and along each of two opposing sides of the respective negative electrode strip;
layering the one or more positive electrode strips and the one or more negative electrode strips so that the end portions of the one or more positive electrode strips are disposed away from the end portions of the one or more negative electrode strips, wherein each positive electrode strip is separated from a respective negative electrode strip by a respective separator strip; and
packaging the layering in a pouch container, the pouch container having a seal on at least two opposing sides, wherein the layering is disposed in the pouch container so that a respective pair of negative and positive tabs extend out through at least two of the seals.

11. The method of claim 10, further comprising:
joining each of the negative tabs using a pair of negative extension tabs, each negative extension tab extending from an opposing side of the layering; and
joining each of the positive tabs using a pair of positive extension tabs, each positive extension tab extending from an opposing side of the layering;
wherein the respective pairs of negative and positive tabs extending out through each of the seals comprises the pairs of negative extension tabs and positive extension tabs.

12. The method of claim 10, wherein the one or more positive electrode strips includes a first positive electrode strip, and the one or more negative electrode strips includes a first negative electrode strip, and wherein layering the one or more positive electrode strips and the one or more negative electrode strips comprises:
interposing a separator strip between the first negative electrode strip and the first positive electrode strip; and
winding the first negative electrode strip, the separator strip, and the first positive electrode strip together to form a roll so that the positive and negative tabs are disposed away from each other and extend outward from opposing sides of the roll.

13. The method of claim 12, further comprising curving the roll around the winding axis using thermal pressing to form a curve-shaped battery cell.

14. The method of claim 10, further comprising curving the layering around an axis parallel to the negative and positive tabs using thermal pressing.

15. The method of claim 10, further comprising curving the layering around an axis perpendicular to the negative and positive tabs using thermal pressing.

16. The method of claim 10, further comprising creating a notch on one side of the layering coinciding with either the positive tab or the negative tab, wherein:
the notch includes a cut through a portion of the one or more positive electrode strips, the one or more negative electrode strips, and the positive or the negative tab corresponding to the side of the layering;
the pouch container has an opening that is aligned with the notch; and
packaging the layering in the pouch container includes placing the layering in the pouch container so that the notch in the layering is aligned with the opening in the pouch container.

17. The method of claim 10, further comprising:
stacking a first layering over a second layering, wherein:
the first layering includes a first one or more positive electrode strips and a first one or more negative electrode strips;
the second layering includes a second one or more positive electrode strips and a second one or more negative electrode strips; and
the stacking includes aligning the negative and positive tabs of the first layering and the second layering;
joining each of the negative tabs of the first layering and the second layering using a second pair of negative extension tabs, each negative extension tab of the second pair of negative extension tabs extending from an opposing side of the first layering and the second layering; and
joining each of the positive tabs of the first layering and the second layering using a second pair of positive extension tabs, each positive extension tab of the second pair of positive extension tabs extending from an opposing side of the first layering and the second layering.

18. A battery system, comprising:
one or more positive electrode strips substantially equal in size, each positive electrode strip having a respective end portion that extends outwardly;
one or more negative electrode strips substantially equal in size to the positive electrode strips, each negative electrode strip having a respective end portion that extends outwardly;
a pouch container having a seal on at least two opposing sides;
the battery system manufactured by a method comprising the steps of:
attaching a positive tab to each end portion of the one or more positive electrode strips, each positive tab substantially perpendicular to and along each of two opposing sides of the respective positive electrode strip;
attaching a negative tab to each end portion of the one or more negative electrode strips, each negative tab substantially perpendicular to and along each of two opposing sides of the respective negative electrode strip;
layering the one or more positive electrode strips and the one or more negative electrode strips so that the end portions of the one or more positive electrode strips are disposed away from the end portions of the one or more negative electrode strips, wherein each positive electrode strip is separated from a respective negative electrode strip by a respective separator strip; and
packaging the layering in the pouch container, wherein the layering is disposed in the pouch container so that a respective pair of negative and positive tabs extend out through at least two of the seals.

19. The battery system of claim 1, wherein a number of positive joining pads in the plurality of positive joining pads is one less than a number of battery cells in the plurality of battery cells, and a number of negative joining pads in the plurality of negative joining pads is one less than the number of battery cells.

20. The battery system of claim 1, wherein the tabs in each pair are aligned along a respective axis.
